(19) United States
(12) Patent Application Publication
(10) Pub. No.: US 2021/0201533 A1
(43) Pub. Date: Jul. 1, 2021

(54) INFORMATION PROCESSING DEVICE, MOBILE BODY, AND LEARNING DEVICE

(71) Applicants: OLYMPUS CORPORATION, Tokyo (JP); THE UNIVERSITY OF TOKYO, Tokyo (JP)

(72) Inventors: Atsuro Okazawa, Tokyo (JP); Tomoyuki Takahata, Tokyo (JP); Tatsuya Harada, Tokyo (JP)

(73) Assignees: OLYMPUS CORPORATION, Tokyo (JP); THE UNIVERSITY OF TOKYO, Tokyo (JP)

(21) Appl. No.: 17/184,929

(22) Filed: Feb. 25, 2021

Related U.S. Application Data
(63) Continuation of application No. PCT/JP2019/007653, filed on Feb. 27, 2019.

(51) Int. Cl. G06T 7/73; H04N 5/225

(52) U.S. Cl. CPC G06T 7/74; H04N 5/2258; G06T 2207/10024; G06T 2207/20081; G06T 2207/10048

(57) ABSTRACT

An information processing device includes an acquisition interface and a processor. The acquisition interface acquires a first detection image obtained by capturing an image of a plurality of target objects including a first target object and a second target object, which is more transparent to visible light than the first target object, using the visible light, and a second detection image obtained by capturing an image of the plurality of target objects using infrared light. The processor obtains a first feature amount based on the first detection image, obtains a second feature amount based on the second detection image, and calculates a third feature amount corresponding to a difference between the first feature amount and the second feature amount. The processor detects a position of the second target object in at least one of the first detection image and the second detection image, based on the third feature amount.

### CROSS REFERENCE TO RELATED APPLICATION

This application is a continuation of International Patent Application No. PCT/JP2019/007653, having an international filing date of Feb. 27, 2019, which designated the United States, the entirety of which is incorporated herein by reference.

### BACKGROUND

Heretofore, a method for performing recognition of an object included in a captured image based on the captured image has widely been known. For example, in a vehicle, a robot, or the like that moves autonomously, object recognition is performed for the movement control such as collision avoidance. It is also important to recognize glass or other similar objects that transmit visible light; however, the characteristics of glass do not fully appear in visible light images.

In view of this issue, Japanese Unexamined Patent Application Publication No. 2007-76378 and Japanese Unexamined Patent Application Publication No. 2010-146094 disclose a method of detecting a transparent object such as glass based on an image captured using infrared light.

In Japanese Unexamined Patent Application Publication No. 2007-76378, a region having a circumference entirely composed of straight edges is regarded as a glass surface. Further, in Japanese Unexamined Patent Application Publication No. 2010-146094, determination as to whether or not the object is glass is made based on the luminance value of an infrared light image, the area of the region, the dispersion of the luminance value, and the like.

### SUMMARY

In accordance with one of some aspect, there is provided an information processing device comprising:

an acquisition interface that acquires a first detection image obtained by capturing an image of a plurality of target objects using visible light and a second detection image obtained by capturing an image of the plurality of target objects using infrared light, the plurality of target objects including a first target object and a second target object, the second target object being more transparent to the visible light than the first target object; and

a processor including hardware,

the processor being configured to:

obtain a first feature amount based on the first detection image;

obtain a second feature amount based on the second detection image;

calculate a third feature amount corresponding to a difference between the first feature amount and the second feature amount, and

detect a position of the second target object in at least one of the first detection image and the second detection image, based on the third feature amount.

In accordance with one of some aspect, there is provided an information processing device, comprising:

an acquisition interface that acquires a first detection image obtained by capturing an image of a plurality of target objects using visible light and a second detection image obtained by capturing an image of the plurality of target objects using infrared light, the plurality of target objects including a first target object and a second target object, the second target object being more transparent to the visible light than the first target object; and

a processor including hardware,

the processor being configured to:

obtain a first feature amount based on the first detection image;

obtain a second feature amount based on the second detection image;

calculate a transmission score indicating a degree of transmission of the visible light with respect to the plurality of target objects whose image is captured in the first detection image and the second detection image, based on the first feature amount and the second feature amount,

calculate a shape score indicating a shape of the plurality of target objects whose image is captured in the first detection image and the second detection image, based on the first detection image and the second detection image, and

distinctively detect a position of the first target object and a position of the second target object in at least one of the first detection image and the second detection image, based on the transmission score and the shape score.

In accordance with one of some aspect, there is provided a mobile body comprising the information processing device as defined in claim 1.

In accordance with one of some aspect, there is provided a learning device, comprising:

an acquisition interface that acquires a data set in which a visible light image obtained by capturing an image of a plurality of target objects including a first target object and a second target object, which is more transparent to visible light than the first target object, using the visible light, an infrared light image obtained by capturing an image of the plurality of target objects using infrared light, and position information of the second target object in at least one of the visible light image and the infrared light image are associated with each other, and

a processor that learns, through machine learning, conditions for detecting a position of the second target object in at least one of the visible light image and the infrared light image, based on the data set.

### BRIEF DESCRIPTION OF THE DRAWINGS

FIG. 1 illustrates a configuration example of an information processing device.

FIG. 2 illustrates a configuration example of an imaging section and an acquisition section.

FIG. 3 illustrates a configuration example of the imaging section and the acquisition section.

FIG. 4 illustrates a configuration example of a processing section.

FIGS. 5A and 5B are schematic diagrams showing opening and closing of a glass door which is a transparent object.

FIG. 6 illustrates examples of a visible light image, an infrared light image, and first to third feature amounts.

FIG. 7 illustrates examples of a visible light image, an infrared light image, and first to third feature amounts.

FIG. 8 is a flowchart explaining processing in a first embodiment.

FIGS. 9A to 9C illustrate examples of mobile body including the information processing device.

FIG. 10 illustrates a configuration example of the processing section.

FIG. 11 is a flowchart explaining processing in a second embodiment.

FIG. 12 illustrates a configuration example of a learning device.

FIG. 13 is a schematic diagram explaining a neural network.

FIG. 14 is a schematic diagram explaining processing in a third embodiment.

FIG. 15 is a flowchart explaining a learning process.

FIG. 16 is a flowchart explaining an inference process.

FIG. 17 illustrates a configuration example of the processing section.

FIG. 18 is a schematic diagram explaining processing in a fourth embodiment.

FIG. 19 is a diagram explaining a transmission score calculation process.

FIG. 20 is a diagram explaining a shape score calculation process.

### DESCRIPTION OF EXEMPLARY EMBODIMENTS

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

Exemplary embodiments are described below. Note that the following exemplary embodiments do not in any way limit the scope of the content defined by the claims laid out herein. Note also that all of the elements described in the present embodiment should not necessarily be taken as essential elements

### 1. First Embodiment

As described above, various methods for detecting an object that transmits visible light, such as glass, have been disclosed. Hereinafter, an object that transmits visible light is referred to as a transparent object, and an object that does not transmit visible light is referred to as a visible object. Visible light refers to light visible to the human eyes. Examples of visible light include light having a wavelength band of about 380 nm to about 800 nm. Since a transparent object transmits visible light, it is difficult to detect its position based on a visible light image. A visible light image is an image captured using visible light.

Japanese Unexamined Patent Application Publication No. 2007-76378 and Japanese Unexamined Patent Application Publication No. 2010-146094 focus attention on the infrared light absorption property of glass, which is a transparent object, and disclose a method of detecting glass based on an infrared light image. Infrared light refers to light having a longer wavelength than visible light, and an infrared light image is an image captured using infrared light.

In Japanese Unexamined Patent Application Publication No. 2007-76378, a region having a circumference entirely composed of straight edges is regarded as a glass surface. However, objects having a circumference entirely composed of straight edges are not limited to glass, and there are many other objects having such a circumference. Therefore, it is difficult to properly distinguish the other objects from glass. Examples of objects having a circumference entirely composed of straight edges include a frame, a display such as a personal computer (PC), and printed objects. For example, a display showing no image has a circumference composed of straight edges, and has a very low internal contrast. Since the image features of glass and the image features of the display in infrared light images are similar, proper detection of glass is difficult.

In Japanese Unexamined Patent Application Publication No. 2010-146094, the determination as to whether or not the object is glass is made based on the luminance value of the infrared light image, the area of the region, the dispersion, and the like. However, in addition to glass, there are other objects similar to glass in terms of features including the luminance value, the area, and the dispersion. For example, it is difficult to distinguish glass from a display of the same size not showing an image. As described above, it is difficult to detect the position of the transparent object only by referring to the image features in a visible light image or the image features in an infrared light image.

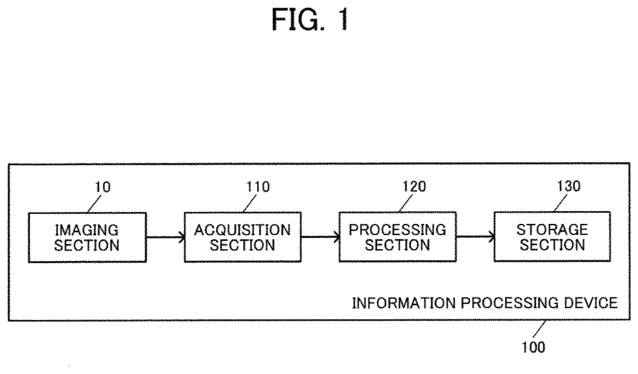

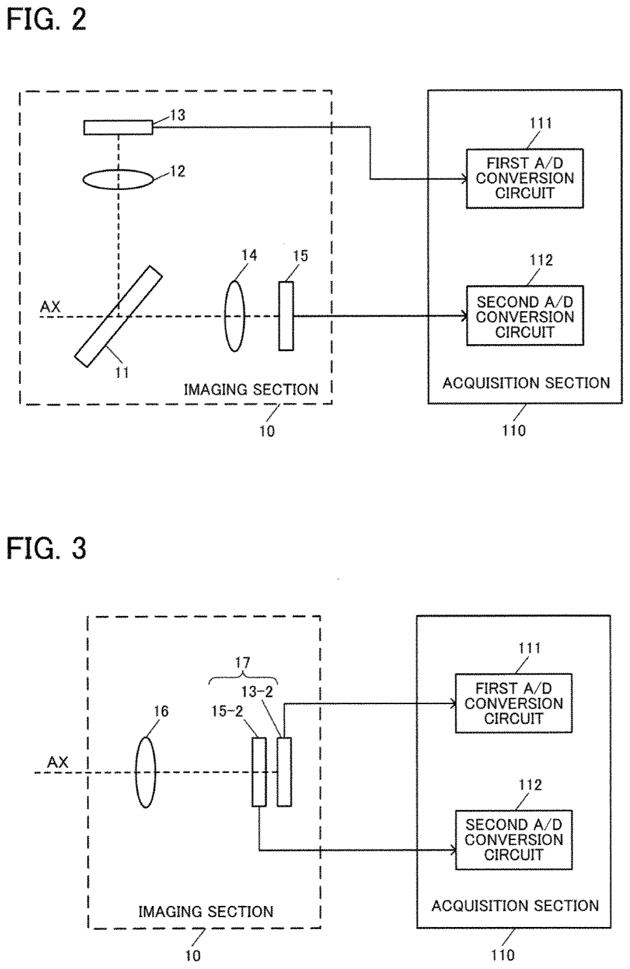

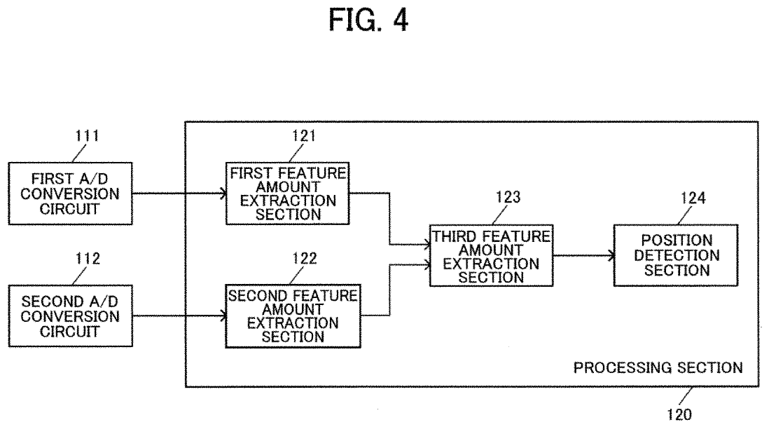

FIG. 1 illustrates a configuration example of an information processing device 100 according to the present embodiment. The information processing device 100 includes an imaging section 10, an acquisition section 110, a processing section 120, and a storage section 130. The imaging section 10 and the acquisition section 110 will be described later with reference to FIGS. 2 and 3. The processing section 120 will be described later with reference to FIG. 4. The storage section 130 serves as a work area for the processing section 120 and the like, and its function can be implemented by a memory such as a random access memory (RAND or a hard disk drive (HDD). The configuration of the information processing device 100 is not limited to the configuration illustrated in FIG. 1, and can be modified in various ways including omitting some of its components or adding other components. For example, the imaging section 10 may be omitted from the information processing device 100. In this case, the information processing device 100 performs processing for acquiring a visible light image and an infrared light image, which will be described later, using an external imaging device.

FIG. 2 is a diagram illustrating configuration examples of the imaging section 10 and the acquisition section 110. The imaging section 10 includes a wavelength separation mirror (dichroic mirror) 11, a first optical system 12, a first imaging element 13, a second optical system 14, and a second imaging element 15. The wavelength separation mirror 11 is an optical element that reflects light in a predetermined wavelength band and transmits light in different wavelength bands. For example, the wavelength separation mirror 11 reflects visible light and transmits infrared light. By using the wavelength separation mirror 11, light from a target object (subject) along an optical axis AX is separated into two directions.

The visible light reflected by the wavelength separation mirror 11 enters into the first imaging element 13 via the first optical system 12. In FIG. 2, a lens is illustrated as an example of the first optical system 12; however, the first optical system may include other components not illustrated in the diagram, such as a diaphragm, a mechanical shutter, and the like. The first imaging element 13 includes a photoelectric conversion element such as a Charge Coupled Device (CCD) or a Complementary Metal-Oxide Semiconductor (CMOS), and outputs a visible light image signal as a result of photoelectric conversion of visible light. The visible light image signal used herein is an analog signal. The first imaging element 13 is an imaging element provided with, for example, the publicly known Bayer-arranged color filter. However, the first imaging element 13 may also be an element having, for example, a complementary color filter, or may be an imaging element of a different type.

The infrared light transmitted through the wavelength separation mirror 11 enters into the second imaging element 15 via the second optical system 14. The second optical system 14 also may include components not illustrated in the diagram, such as a diaphragm, a mechanical shutter, and the like, in addition to the lens. The second imaging element 15 includes a photoelectric conversion element such as a microbolometer or InSb (Indium Antimonide), and outputs an infrared light image signal as a result of photoelectric conversion of the infrared light. The infrared light image signal herein means an analog signal.

The acquisition section 110 includes a first A/D conversion circuit 111 and a second A/D conversion circuit 112. The first A/D conversion circuit 111 performs A/D conversion with respect to the visible light image signal from the first imaging element 13, and outputs visible light image data as digital data. The visible light image data is, for example, image data of RGB (three) channels. The second A/D conversion circuit 112 performs A/D conversion with respect to the infrared light image signal from the second imaging element 15, and outputs infrared light image data as digital data. The infrared light image data is, for example, image data of a single channel. Hereinafter, visible light image data and infrared light image data, which are digital data, are simply referred to as a visible light image and an infrared light image.

FIG. 3 is a diagram illustrating another configuration example of the imaging section 10 and the acquisition section 110. The imaging section 10 includes a third optical system 16 and an imaging element 17. The third optical system may include components not illustrated in the diagram, such as a diaphragm, a mechanical shutter, and the like, in addition to the lens. The imaging element 17 is a lamination-type imaging element in which a first imaging element 13-2 for receiving visible light and a second imaging element 15-2 for receiving infrared light are laminated in a direction along the optical axis AX.

In the example shown in FIG. 3, imaging of infrared light is performed by the second imaging element 15-2, which is relatively close to the third optical system 16. The second imaging element 15-2 outputs an infrared light image signal to the acquisition section 110. The imaging of visible light is performed by the first imaging element 13-2, which is relatively far from the third optical system 16. The first imaging element 13-2 outputs a visible light image signal to the acquisition section 110. Since the method of laminating a plurality of imaging elements, which are made to capture target objects in different wavelength bands, in the optical axis direction is widely known, a detailed description thereof is omitted here.

As in FIG. 2, the acquisition section 110 includes the first A/D conversion circuit 111 and the second A/D conversion circuit 112. The first A/D conversion circuit 111 performs A/D conversion with respect to the visible light image signal from the first imaging element 13-2, and outputs visible light image data as digital data. The second A/D conversion circuit 112 performs A/D conversion with respect to the infrared light image signal from the second imaging element 15-2, and outputs infrared light image data as digital data.

The acquisition section 110 is not limited to the configuration shown in FIGS. 2 and 3. For example, the acquisition section 110 may include an analog amplifier circuit that performs amplification with respect to the visible light image signal and the infrared light image signal. The acquisition section 110 performs A/D conversion with respect to the image signal resulting from the amplification. It is possible to provide an analog amplifier circuit in the imaging section 10 instead of providing it in the acquisition section 110. Although FIG. 2 shows an example in which the acquisition section 110 performs A/D conversion, the imaging section 10 may perform A/D conversion. In this case, the imaging section 10 outputs visible light images and infrared light images as digital data. The acquisition section 110 is an interface for acquiring digital data from the imaging section 10.

As described above, the imaging section 10 captures an image of a target object using visible light with a first optical axis, and captures an image of a target object using infrared light with a second optical axis, which corresponds to the first optical axis. As described later, the target object described herein means a plurality of target objects including a first target object, and a second target object, which is more transparent to visible light than the first target object. Specifically, the first target object is a visible object which reflects visible light, and the second target object is a transparent object which transmits visible light. In the narrow sense, the first optical axis and the second optical axis refer to the same axis shown as the optical axis AX in FIGS. 2 and 3. The imaging section 10 may be included in the information processing device 100. The acquisition section 110 acquires a first detection image and a second detection image based on the image-capturing by the imaging section 10. The first detection image is a visible light image, and the second detection image is an infrared light image.

As is thus clear, the imaging section 10 is capable of coaxially capturing an image of the same target object both using visible light and infrared light. Therefore, it is possible to easily associate the position of a transparent object in the visible light image with the position of the transparent object in the infrared light image. For example, in the case where the visible light image and the infrared light image have the same angle of view and the same number of pixels, an image of a given target object is captured in the pixels at the same position of the visible light image and the infrared light image. The pixel position refers to information indicating the location of the pixel in terms of the horizontal direction and the same in terms of the vertical direction with respect to the reference pixel. Therefore, by associating the information of the pixel at the same position, it is possible to appropriately perform a process that uses information of both of the visible light image and the infrared light image. For example, as will be described later, it is possible to appropriately detect the position of the second target object, which is a transparent object, using a first feature amount based on the first detection image and a second feature amount based on the second detection image. Insofar as the imaging section 10 is configured so that the position of the target object can be associated between the visible light image and the infrared light image, its configuration is not limited to the above-described configuration. For example, the first optical axis and the second optical axis need only be substantially equal to each other, and need not to exactly coincide with each other. Further, the number of pixels in the visible light image and the number of pixels in the infrared light image need not be identical.

FIG. 4 is a diagram illustrating a configuration example of the processing section 120. The processing section 120 includes a first feature amount extraction section 121, a second feature amount extraction section 122, a third feature amount extraction section 123, and a position detection section 124. The processing section 120 of the present embodiment is constituted of the following hardware. The hardware may include at least one of a circuit for processing digital signals and a circuit for processing analog signals. For example, the hardware may include one or a plurality of circuit devices or one or a plurality of circuit elements mounted on a circuit board. The one or a plurality of circuit devices are, for example, an integrated circuit (IC). The one or a plurality of circuit elements are, for example a resistor or a capacitor.

The processing section 120 may be implemented by the following processor. The information processing device 100 of the present embodiment includes a memory for storing information and a processor that operates based on the information stored in the memory. The information includes, for example, a program and various types of data. The processor includes hardware. The processor may be one of various processors including CPU (Central Processing Unit), a GPU (Graphics Processing Unit), a DSP (Digital Signal Processor), and the like. The memory may be a semiconductor memory such as an SRAM (Static Random Access Memory) or a DRAM (Dynamic Random Access Memory), or may be a register. The memory may also be a magnetic storage device such as a hard disk device, or an optical storage device such as an optical disc device. For example, the memory stores computer-readable instructions, and functions of the respective sections of the information processing device 100 are implemented as the processor executes the instructions. These instructions may be an instruction set included in a program, or may be instructions that cause operations of the hardware circuit included in the processor.

The first feature amount extraction section 121 acquires the first detection image, which is a visible light image, from the first A/D conversion circuit 111 of the acquisition section 110. The second feature amount extraction section 122 acquires the second detection image, which is an infrared light image, from the second A/D conversion circuit 112 of the acquisition section 110. The visible light image and the infrared light image are not limited to those transmitted directly from the acquisition section 110 to the processing section 120. For example, the acquisition section 110 may perform writing of the acquired visible light image and the infrared light image into the storage section 130, and the processing section 120 may perform readout of the acquired visible light image and the infrared light image from the storage section 130.

The first feature amount extraction section 121 extracts a feature amount of the first detection image (visible light image) as the first feature amount. The second feature amount extraction section 122 extracts a feature amount of the second detection image (infrared light image) as the second feature amount. Various feature amounts, such as luminance or contrast, may be used as the first feature amount and the second feature amount. For example, the first feature amount is edge information obtained by applying an edge extraction filter to the visible light image. The second feature amount is edge information obtained by applying an edge extraction filter to the infrared light image. The edge extraction filter is a highpass filter such as a Laplacian filter.

In the following, with regard to a transparent object, which transmits visible light, and a visible object, which does not transmit visible light, their tendencies in the visible light image and the infrared light image are discussed. Since the transparent object transmits visible light, the feature of the transparent object does not easily appear in a visible light image. More specifically, the feature of a transparent object is not significantly reflected in the first feature amount. Further, since the transparent object absorbs infrared light, the feature of the transparent object appears in the infrared light image. More specifically, the feature of a transparent object is easily reflected in the second feature amount. On the other hand, the degree of transmission of visible light and infrared light are both small in a visible object. Therefore, the feature of a visible object appears both in the visible light image and the infrared light image. More specifically, the feature of a visible object influences both the first feature amount and the second feature amount.

In consideration of the above point, the third feature amount extraction section 123 calculates the difference between the first feature amount and the second feature amount as a third feature amount. By taking the difference between the first feature amount and the second feature amount, information indicating the feature of the transparent object is emphasized. More specifically, the second feature amount based on the infrared light image is emphasized. On the other hand, the feature of the visible object included both in the first feature amount and the second feature amount is canceled by the difference calculation. Therefore, the feature amount of the transparent object dominantly appears in the third feature amount.

The position detection section 124 detects position information of a transparent object in at least one of a visible light image and an infrared light image on the basis of the third feature amount, and then outputs a detection result. For example, when the third feature amount is information indicating an edge, the position detection section 124 outputs, as position information, information indicating the positions of the edges of the transparent object or information indicating the position of an area surrounded by the edges.

When the conditions including the optical axis, the angle of view, and the number of pixels, and the like are equal between the visible light image and the infrared light image, the position of the transparent object in the visible light image is equivalent to the position of the transparent object in the infrared light image. Even if there is a difference in the optical axis or the like, the present embodiment assumes that the position of a given target object in the visible light image can be associated with the position of the target object in the infrared light image. Therefore, the position information of the transparent object in one of the visible light image and the infrared light image can be specified based on the position information of the transparent object in the other. The position detection section 124 may obtain the position information of the transparent object in both the visible light image and the infrared light image, or may obtain the position information of the transparent object in either of the visible light image and the infrared light image.

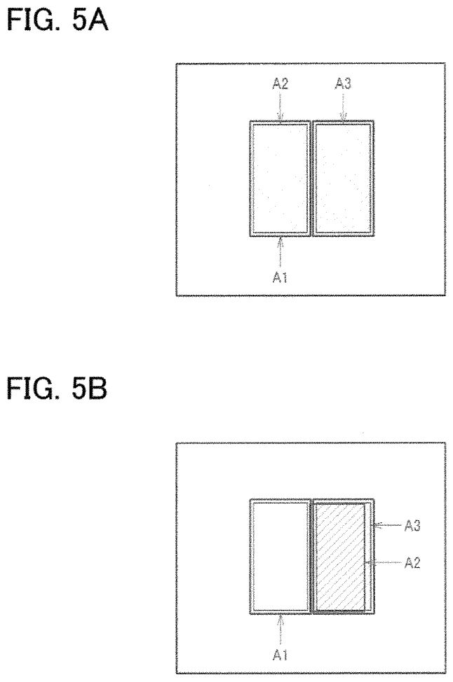

FIGS. 5A and 5B are diagrams illustrating a glass door, which is an example of a transparent object. FIG. 5A shows a closed state of a glass door, and FIG. 5B shows an open state of a glass door. In the examples shown in FIGS. 5A and 5B, two glasses represented by A2 and A3 are placed in a rectangular region shown in A1. The glass door is opened and closed by the horizontal movement of the glass represented by A2, which is one of the two glasses. In the closed state shown in FIG. 5A, the two glasses represented by A1 and A2 are placed in almost the entire region of A1. In the open state shown in FIG. 5B, there is no glass in the left region of A1, and two glasses are overlapped in the right region. The region other than A1 is, for example, a wall surface of a building. For ease of description, it is assumed herein that the object is a uniform object having no irregularities and little change in color.

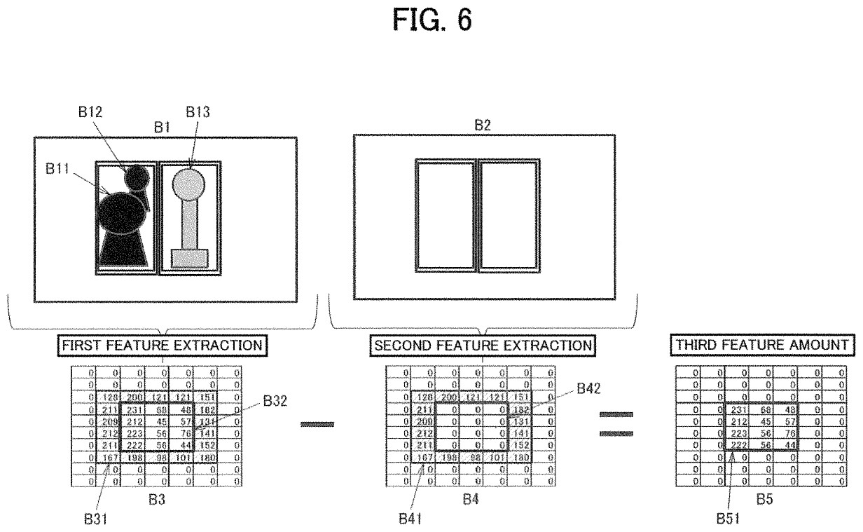

FIG. 6 is a diagram illustrating an example of a visible light image, an example of an infrared light image, and examples of the first to third feature amounts, in a state where the glass door is closed. In FIG. 6, B1 is an example of a visible light image, and B2 is an example of an infrared light image. Since visible light transmits the glass, the visible light image is taken by capturing an image of a target object residing in the back side of the glass in the region where the glass is present. “The back side” refers to a space having a longer distance from the imaging section 10, compared with the distance of the glass from the imaging section 10. In the example shown in B1 in FIG. 6, images of visible objects B11 to B13 residing in the back side of the glass are captured.

B3 is an example of the first feature amount obtained by applying an edge extraction filter or the like to the visible light image of B1. As described above, for example, an image of a wall surface of a building is captured in the region other than the glass, and an image of objects in the back side of the glass, such as B11 to B13, are captured in a region where the glass is present. Since different objects are imaged in the glass region and other regions, the edge is detected at the boundary. As a result, the value of the first feature amount increases at the boundary of the glass region (B31). Further, within the region where the glass is present, an edge originating from the objects in the back side of the glass, such as B11 to B13, is detected; therefore, the value of the first feature amount increases to some extent (B32).

Further, since the infrared light is absorbed by the glass, in the infrared light image shown in B2, the image of the region where the glass is present is captured as a region having a small luminance and low contrast. Further, even if an object exists in the back side of the glass, an image of the object is not captured in the infrared light image.

B4 is an example of the second feature amount obtained by applying an edge extraction filter or the like to the infrared light image of B2. Since there is a luminance difference between the region other than the glass and the region where the glass is present, the value of the second feature amount becomes large at the boundary of the glass region (B41). Since the region where the glass is present has low contrast as described above, the value of the second feature amount is very small (B42).

B5 is an example of the third feature amount, which is a difference between the first feature amount and the second feature amount. By taking the difference, the value of the third feature amount becomes large in B51, which is a region corresponding to the glass. On the other hand, in other regions, similar features are detected in the visible light image and the infrared light image; therefore, the value of the third feature amount obtained by the difference becomes small. For example, in the boundary between the glass region and the visible object, since edge is detected both in the first feature amount and the second feature amount, the edge is canceled. Further, in the visible object other than the glass region, the value is also canceled because the first feature amount and the second feature amount have a similar tendency. Although FIG. 6 shows an example in which the visible object has a low contrast, the feature is still canceled by the difference even if the visible object has an edge.

In the example shown in FIG. 6, the position detection section 124 regards a pixel having a third feature amount larger than a given threshold as the pixel corresponding to the transparent object. For example, the position detection section 124 determines the position and the shape corresponding to the transparent object based on a region that connects the pixels having a third feature amount larger than a given threshold. The position detection section 124 stores the position information of the detected transparent object in the storage section 130. Alternatively, the information processing device 100 may include a display section (not shown), and the position detection section 124 may output image data for presenting the position information of the detected transparent object to the display section. The image data herein refers to, for example, information obtained by adding information representing the position of the transparent object to a visible light image.

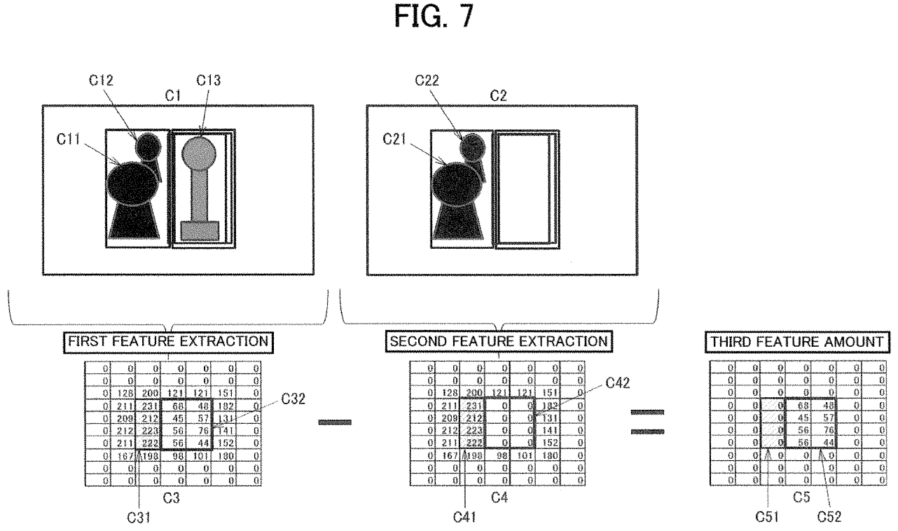

The method of the present embodiment can be used to the determination as to whether the glass door is open or closed. FIG. 7 is a diagram illustrating an example of a visible light image, an example of an infrared light image, and examples of the first to third feature amounts, in a state where the glass door is open. In FIG. 7, C1 is an example of a visible light image, and C2 is an example of an infrared light image. C3 to C5 are examples of the first to third feature amounts.

When the glass door is open, the left region relative to the glass door becomes an opening in which glass is absent. Infrared light emitted from a target object located in the back side of the glass door can reach the imaging section 10 without being absorbed by the glass. Therefore, images of C11 and C12 are captured in the visible light image, and also images of the same target objects (C21 and C22) are captured in the infrared light image. On the other hand, the right region in which the glass is present is the same as that in the closed state; therefore, although an image of the target object (C13) in the back side is captured in the visible light image, an image of the target object is not captured in the infrared light image.

As a result, in the left region where the glass is absent, the values of both the first feature amount and the second feature amount increase, and are canceled by the difference (C31, C41, C51). On the other hand, in the right region where the glass is present, since the first feature amount reflects the feature of the object in the back side and the second feature amount has a low contrast, the value of the third feature amount increases by the difference (C32, C42, C52).

The previously-known methods are methods for determining a feature such as a shape or a texture of an object based on a visible light image and an infrared light image, and discriminating glass based on the feature. Therefore, a rectangular frame having a low contrast is difficult to be distinguished from other target objects. However, as described with reference to FIGS. 6 and 7, the method of the present embodiment uses the difference between the target objects to be imaged in terms of the wavelength band; that is, an image of glass is captured using infrared light, and an image of the target object in the back side is captured using visible light that transmits the glass. In the region where the transparent object is present, images of different target objects are captured. Therefore, the difference in feature becomes large even if the shape and the texture are the same. In contrast, in the region that is not the transparent object, an image of the same target object is captured; therefore the difference in feature is insignificant. The method of the present embodiment is capable of detecting a transparent object with higher accuracy than the previously-known method by using the third feature amount corresponding to the difference between the first feature amount and the second feature amount. Further, as described with reference to FIGS. 6 and 7, it is possible to detect not only the presence or absence of the transparent object but also its position and the shape. Furthermore, as described with reference to FIG. 7, erroneous detection by determining an open area, which is generated as a result of movement of the transparent object, as a transparent object can be prevented in this method; therefore, it becomes possible to detect a movable transparent object. More specifically, it becomes possible to determine whether a glass door or the like is open or closed.

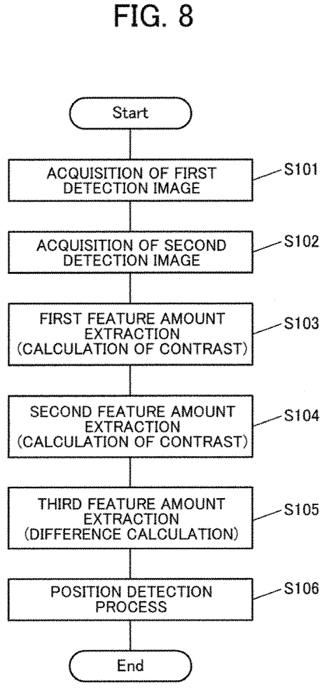

FIG. 8 is a flowchart explaining processing according to the present embodiment. When the processing is started, the acquisition section 110 acquires a visible light image as the first detection image and an infrared light image as the second detection image (S101, S102). For example, the processing section 120 controls the imaging section 10 and the acquisition section 110. Next, the processing section 120 extracts the first feature amount based on the visible light image and extracts the second feature amount based on the infrared light image (S103, S104). The processing in S103 and S104 is a filtering process using an edge extraction filter as described above. However, as described above with reference to FIGS. 6 and 7, the method of the present embodiment detects a transparent object based on whether or not the object to be imaged is the same or different. Therefore, insofar as the first feature amount and the second feature amount are information reflecting the feature of the object to be imaged, they are not limited to an edge.

Subsequently, the processing section 120 extracts the third feature amount by calculating the difference between the first feature amount and the second feature amount (S105). The processing section 120 detects the position of the transparent object based on the third feature amount (S106). The processing in S106 is, for example, a process of a comparison between the value of the third feature amount and a given threshold as described above.

As is clear from the above, the information processing device 100 of the present embodiment includes the acquisition section 110 and the processing section 120. The acquisition section 110 acquires the first detection image obtained by capturing an image of a plurality of target objects including the first target object and the second target object, which is more transparent to the visible light than the first target object, using visible light, and the second detection image obtained by capturing an image of the plurality of target objects using infrared light. The processing section 120 obtains the first feature amount based on the first detection image, obtains the second feature amount based on the second detection image, and calculates a feature amount corresponding to the difference between the first feature amount and the second feature amount as the third feature amount. The processing section 120 detects the position of the second target object in at least one of the first detection image and the second detection image based on the third feature amount.

The above described an example in which the third feature amount is the difference between the first feature amount and the second feature amount. However, insofar as the third feature amount is a feature amount that is obtained by a calculation corresponding to the difference, that is, insofar as it is a feature amount that is obtained by a calculation capable of canceling the feature included in both the first feature amount and the second feature amount, the calculation is not limited to the difference itself. For example, a process of inverting one of the signs of the second feature amount and then adding it is included in the calculation corresponding to the difference. The third feature amount extraction section 123 may calculate the third feature amount by multiplying the first feature amount by a first coefficient, multiplying the second feature amount by a second coefficient, and then summing the two multiplication results. The third feature amount extraction section 123 may determine the ratio of the first feature amount to the second feature amount or information equivalent thereto as the feature amount corresponding to the difference. In this case, the position detection section 124 determines that a pixel in which the third feature amount, which is a ratio, deviates from 1 by a predetermined threshold or more, is a transparent object.

The method of the present embodiment obtains feature amounts respectively from a visible light image and an infrared light image, and a transparent object is detected using the feature amount based on the difference between them. This makes it possible to detect the position of the transparent object with high accuracy while taking into account the feature of the visible object in the visible light image, the feature of the transparent object in the visible light image, the feature of the visible object in the infrared light image, and the feature of the transparent object in the infrared light image.

Further, the first feature amount is information indicating the contrast of the first detection image, and the second feature amount is information indicating the contrast of the second detection image. The processing section 120 detects the position of the second target object in at least one of the first detection image and the second detection image based on the third feature amount corresponding to the difference between the contrast of the first detection image and the contrast of the second detection image.

In this way, it is possible to detect the position of the transparent object by using a contrast as a feature amount. The contrast used herein refers to information indicating the degree of difference in pixel value between a given pixel and a pixel in the vicinity of the given pixel. For example, the edge described above is information indicating a region with a rapid change of pixel value, and therefore is included in the information indicating a contrast. It should be noted that various image processing methods of obtaining the contrast are known and they can be widely applied in this embodiment. For example, the contrast may be information based on the difference between the maximum value and the minimum value of the pixel value in a predetermined region. The information indicating a contrast may also be information in which the value increases in a region having a low contrast.

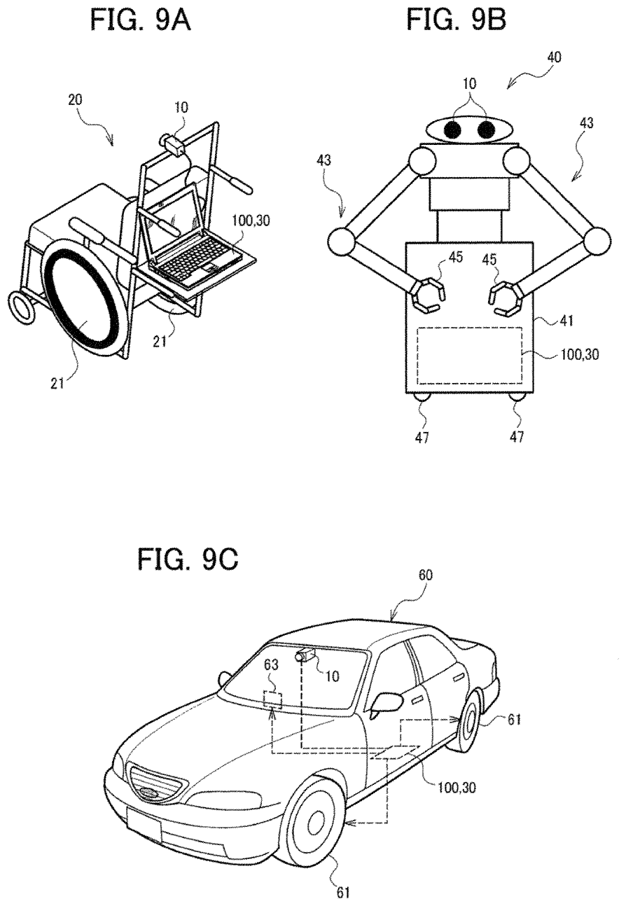

The method of the present embodiment can be applied to a mobile body including the information processing device 100 described above. The information processing device 100 can be incorporated into various mobile bodies such as automobiles, airplanes, motorbikes, bicycles, robots, ships, and the like. The mobile body is, for example, an instrument or a device that is provided with a drive mechanism such as an engine or a motor, a steering mechanism such as a steering wheel or a helm, and various electronic devices, and that moves on the ground, in the air, or on the sea. The mobile body includes, for example, the information processing device 100, and a control device 30 which controls the movement of the mobile body. FIGS. 9A to 9C illustrate examples of the mobile body according to the present embodiment. FIGS. 9A to 9C show examples in which the imaging section 10 is provided outside the information processing device 100.

In the example shown in FIG. 9A, the mobile body is, for example, a wheelchair 20 that performs autonomous travel. The wheelchair 20 includes the imaging section 10, the information processing device 100, and the control device 30. Although FIG. 9A shows an example in which the information processing device 100 and the control device 30 are provided integrally, they may also be provided as separate devices.

The information processing device 100 detects the position information of a transparent object by performing the above-described processing. The control device 30 acquires the position information detected by the position detection section 124 from the information processing device 100. The control device 30 controls a driving section for preventing the collision between the wheelchair 20 and the transparent object based on the acquired position information of the transparent object. The driving section herein refers to, for example, a motor for rotating wheels 21. Since various techniques for controlling a mobile body to avoid collision with an obstacle are known, a detailed description thereof is omitted.

The mobile body may be a robot shown in FIG. 9B. The robot 40 includes the imaging section 10 provided on the head, the information processing device 100 and the control device 30 incorporated in a main body 41, arms 43, hands 45, and wheels 47. The control device 30 controls a driving section for preventing collision between the robot 40 and a transparent object based on the position information of the transparent object detected by the position detection section 124. For example, the control device 30 performs processing for generating a movement path of the hands 45 to avoid the collision with the transparent object based on the position information of the transparent object, processing for generating an arm posture to enable the hands 45 to move along the movement path while preventing the arms 43 from colliding with the transparent object, processing for controlling the driving section based on the generated information, and the like. The driving section herein refers to a motor for driving the arms 43 and the hands 45. The driving section includes a motor for driving the wheels 47, and the control device 30 may perform wheel driving control for preventing collision between the robot 40 and the transparent object. Although a robot having arms is illustrated in FIG. 9B, the method of the present embodiment can be applied to various types of robots.

The mobile body may be an automobile 60 shown in FIG. 9C. The automobile 60 includes the imaging section 10, the information processing device 100, and the control device 30. The imaging section 10 is an on-board camera which can be used together with, for example, a drive recorder. The control device 30 performs various types of control processing for automatic driving based on the position of the transparent object detected by the position detection section 124. The control device 30 controls the brake of each wheel 61, for example. The control device 30 may also perform the control to display the result of detection of the transparent object on a display section 63.

### 2. Second Embodiment

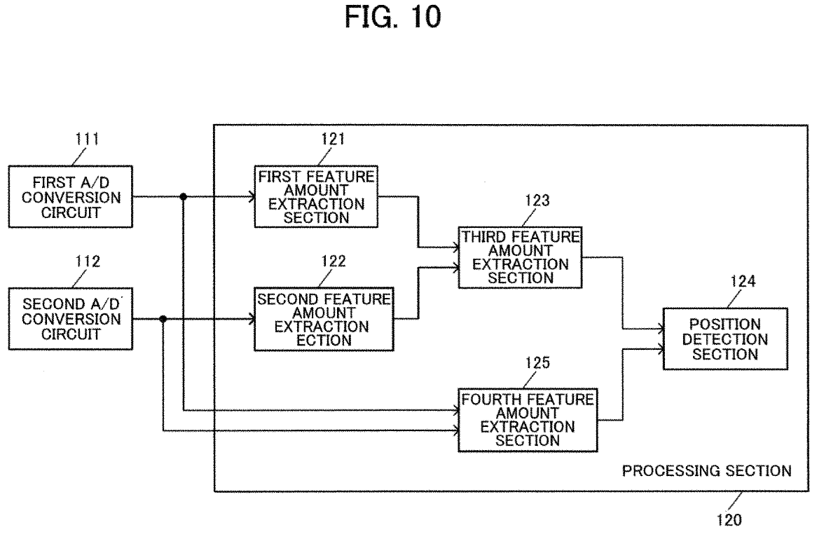

FIG. 10 is a diagram illustrating a configuration example of the processing section 120 according to a second embodiment. In addition to the configuration shown in FIG. 4, the processing section 120 further includes a fourth feature amount extraction section 125 for calculating the fourth feature amount.

As in a first embodiment, the third feature amount extraction section 123 calculates the difference between the first feature amount and the second feature amount, thereby calculating the third feature amount that is dominant for the transparent object. By using the third feature amount, the position of the transparent object can be detected with high accuracy.

The fourth feature amount extraction section 125 detects a feature amount of a visible object as the fourth feature amount by using the third detection image, which is an image obtained by combining the first detection image (visible light image) and the second detection image (infrared light image). The third detection image is, for example, an image obtained by combining the pixel value of the visible light image and the pixel value of the infrared light image for each pixel. Specifically, the fourth feature amount extraction section 125 generates the third detection image by calculating an average value of the pixel value of an image R corresponding to the red light, the pixel value of an image G corresponding to the green light, the pixel value of an image B corresponding to the blue light, and the pixel value of an infrared light image for each pixel. The average herein may be a simple average or a weighted average. For example, the fourth feature amount extraction section 125 may obtain a luminance image signal Y based on the three (RGB) images, and may combine the luminance image signal with the infrared light image.

The fourth feature amount extraction section 125 obtains the fourth feature amount, for example, by performing a filtering process using an edge extraction filter with respect to the third detection image. However, the fourth feature amount is not limited to an edge, and various modifications can be made. The fourth feature amount extraction section 125 may calculate the fourth feature amount using the third detection image or may also obtain the fourth feature amount by summing the feature amounts individually extracted from the visible light image and the infrared light image.

The position detection section 124 detects the position of the transparent object based on the third feature amount, and detects the position of the visible object based on the fourth feature amount. In this way, the position detection section 124 performs position detection of both the transparent object and the visible object while distinguishing them from each other. The position detection section 124 may also distinctively detect the transparent object and the visible object by using the third feature amount and the fourth feature amount together.

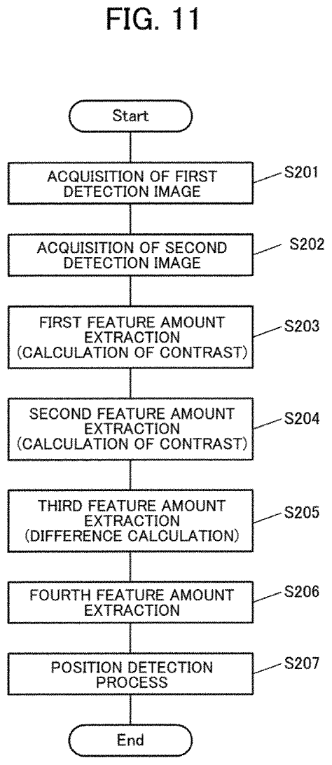

FIG. 11 is a flowchart explaining processing according to the present embodiment. Steps S201 to S205 in FIG. 11 are the same as steps S101 to S105 in FIG. 8, and the processing section 120 obtains the third feature amount based on the first feature amount and the second feature amount. Further, the processing section 120 extracts the fourth feature amount based on the visible light image and the infrared light image (8206). For example, as described above, the processing section 120 obtains the third detection image by combining the visible light image and the infrared light image, and extracts the fourth feature amount from the third detection image.

The processing section 120 then detects the position of the transparent object and the position of the visible object based on the third feature amount and the fourth feature amount (S207). The processing in S207 includes, for example, detection of the transparent object by comparing the value of the third feature amount and a given threshold, and detection of the visible object by comparing the value of the fourth feature amount and another threshold.

As described above, the processing section 120 of the present embodiment determines the fourth feature amount representing the feature of the first target object based on the first detection image and the second detection image. Further, based on the third feature amount and the fourth feature amount, the processing section 120 distinctively detects the position of the first target object and the position of the second target object. This makes it possible to appropriately detect the position of each object in the image even when the visible object and the transparent object are mixed in the image. Further, since the feature amount by visible light is insufficient in a dark scene, the accuracy in the detection of a visible object may be lowered if only the visible light image is used. In this regard, since the method of the present embodiment uses both the visible light image and the infrared light image in the extraction of the fourth feature amount, it is possible to accurately detect the visible object even in a dark scene.

### 3. Third Embodiment

In the second embodiment, in order to obtain the third feature amount and the fourth feature amount used for the position detection, it is necessary to set characteristics such as an edge extraction filter in advance. For example, the user manually sets filter characteristics to enable appropriately extraction of the features of a visible object or a transparent object. However, it is also possible to use machine learning for the position detection including the extraction of feature amount.

The information processing device 100 of the present embodiment includes the storage section 130 for storing a trained model. The trained model is machine-trained based on a data set in which a first training image and a second training image, and the position information of the first target object and the position information of the second target object are associated. The first training image is a visible light image obtained by capturing an image of a plurality of target objects including the first target object (visible object) and the second target object (transparent object) using visible light. The second training image is an infrared light image obtained by capturing an image of the plurality of target objects using infrared light. The processing section 120 distinctively detects both the position of the first target object and the position of the second target object in at least one of the first detection image and the second detection image based on the first detection image, the second detection image, and the trained model.

By thus using the machine learning, the positions of the visible object and the transparent object can be detected with high accuracy. The learning process and the inference process using the trained model are described below. Although the machine learning using a neural network is described below, the method of the present embodiment is not limited to this technique. In the present embodiment, the machine learning using other models such as SVM (support vector machine) may also be performed, or the machine learning using an advanced method developed from various techniques such as a neural network, SVM, and the like may also be performed.

### 3.1 Learning Process

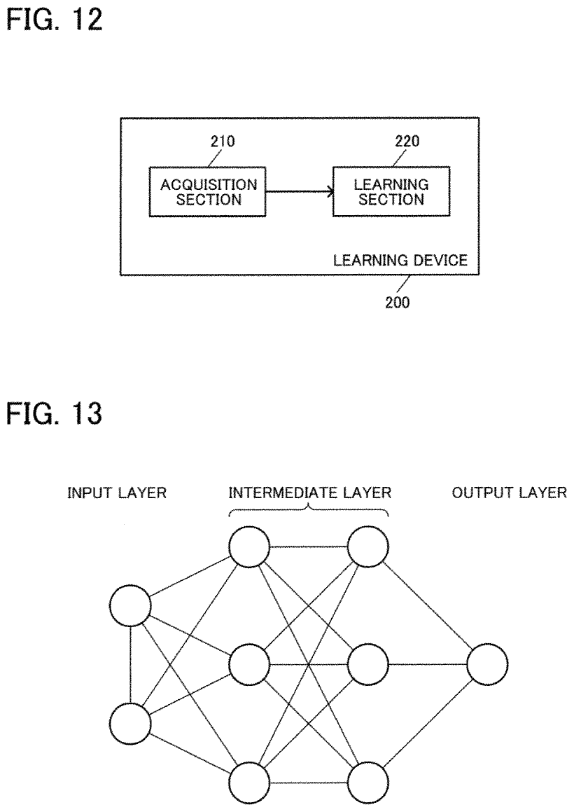

FIG. 12 illustrates a configuration example of a learning device 200 according to the present embodiment. The learning device 200 includes an acquisition section 210 for acquiring training data used for the learning, and a learning section 220 that undergoes machine learning based on the training data.

The acquisition section 210 is, for example, a communication interface for acquiring training data from another device. The acquisition section 210 may also acquire training data stored in the learning device 200. For example, the learning device 200 includes a storage section (not shown), and the acquisition section 210 is an interface for reading out training data from the storage section. The learning in the present embodiment is, for example, supervised learning. The training data for supervised learning is a data set in which input data are associated with correct answer labels.

The learning section 220 undergoes machine learning based on the training data acquired by the acquisition section 210, and generates a trained model. The learning section 220 of the present embodiment is configured by hardware including at least one of a circuit for processing a digital signal and a circuit for processing an analog signal, as in the processing section 120 of the information processing device 100. For example, the hardware may include one or a plurality of circuit devices or one or a plurality of circuit elements mounted on a circuit board. The learning device 200 may include a processor and a memory, and the learning section 220 may be implemented by various processors such as a CPU, a GPU, or a DSP. The memory may be a semiconductor memory, a register, a magnetic storage device, or an optical storage device.

More specifically, the acquisition section 210 acquires a data set in which a visible light image obtained by capturing an image of a plurality of target objects including the first target object and the second target object which is more transparent to the visible light than the first target object using visible light and an infrared light image obtained by capturing an image of the plurality of target objects using infrared light are associated with the position information of the first target object and the position information of the second target object in at least one of the visible light image and the infrared light image. The learning section 220 learns, through machine learning, conditions for detecting the first target object and conditions for detecting the position of the second target object in at least one of the visible light image and the infrared light image, based on the data set.

By performing such machine learning, it becomes possible to detect the positions of the visible object and the transparent object with high accuracy. For example, in the second embodiment, it is necessary for the user to manually set the filter characteristics for extracting the first feature amount, the second feature amount, and the fourth feature amount. Therefore, it is difficult to set a large number of filters capable of efficiently extracting the features of the visible object and the transparent object. In this regard, by using machine learning, it becomes possible to automatically set a large number of filter characteristics. Therefore, it becomes possible to detect the positions of the visible object and the transparent object with higher accuracy in comparison with the second embodiment.

FIG. 13 is a schematic diagram explaining a neural network. The neural network includes an input layer to which data is input, an intermediate layer for performing arithmetic operation based on an output from the input layer, and an output layer for outputting data based on an output from the intermediate layer. Although FIG. 13 illustrates an example using a network having two intermediate layers, it is possible to use a single intermediate layer or three or more intermediate layers. The number of nodes (neurons) included in each layer is not limited to that in the example of FIG. 13, and various modifications can be made. In view of accuracy, the learning of the present embodiment is preferably performed by deep learning using a multilayer neural network. The term “multilayer” used herein refers to four or more layers in the narrow sense.

As shown in FIG. 13, a node included in a given layer is connected to a node of an adjacent layer. A weight is set for each connection. For example, when a fully-connected neural network in which each node included in a given layer is connected to all nodes of the next layer is used, the weight between these two layers is a set of values obtained by multiplying the number of nodes included in the given layer by the number of nodes included in the next layer. Each node multiplies the output of the node of the preceding stage by the weight, thereby obtaining the sum of the multiplication results. Each node further determines the output of the node by adding a bias to the sum and applying an activation function to the addition result. The ReLU function is known as the activation function. However, various functions can be used as the activation function. It is possible to use a sigmoid function, a function obtained by modifying the ReLU function, or other functions.

By sequentially executing the above processing from the input layer to the output layer, the output of the neural network is obtained. The learning in the neural network is a process of determining an appropriate weight (including a bias). Various methods, including an error back-propagation method, have been known as the method to carry out such learning. They can be widely applied in this embodiment. Since the error back-propagation method is publicly known, a detailed description thereof is omitted.

However, the neural network is not limited to the configuration shown in FIG. 13. For example, a convolutional neural network (CNN) may be used in the learning process and the inference process. CNN includes, for example, a convolution layer and a pooling layer for performing a convolution operation. The convolution layer is a layer for performing filtering. The pooling layer is a layer for performing a pooling operation for reducing the size in the vertical direction and the horizontal direction. The weight in the convolution layer of CNN is a parameter of the filter. More specifically, the learning in CNN includes learning of filter characteristics used in the convolution operation.

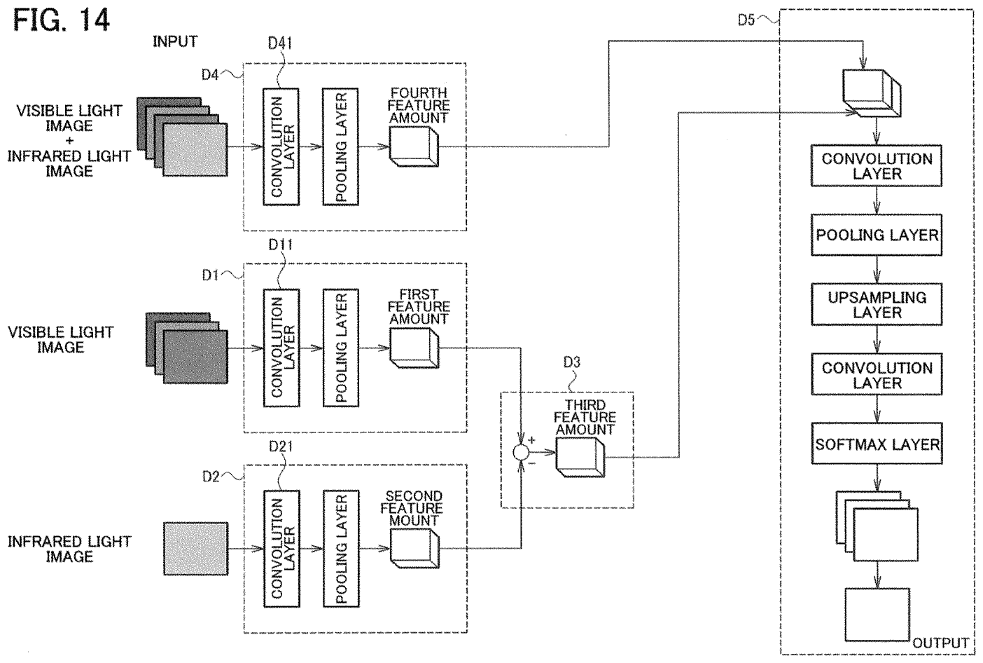

FIG. 14 is a schematic diagram illustrating a structure of a neural network of the present embodiment. D1 in FIG. 14 is a block for determining the first feature amount by receiving a 3-channel visible light image as an input and performing a process including a convolution operation. The first feature amount is, for example, a first feature map of 256 channels obtained by performing 256 kinds of filtering with respect to the visible light image. The number of channels of the feature map is not limited to 256, and various modifications can be made.

D2 is a block for determining the second feature amount by receiving a 1-channel infrared light image as an input and performing a process including a convolution operation. The second feature amount is, for example, a second feature map of 256 channels.

D3 is a block for determining the third feature amount by performing a process for determining the difference between the first feature map and the second feature map. The third feature amount is, for example, a third feature map of 256 channels obtained by performing, for each channel, a process for subtracting each pixel value of the feature map of the i-th (i is an integer from 1 to 256) channel of the second feature map from each pixel value of the feature map of the i-th channel of the first feature map.

D4 is a block for determining the fourth feature amount by receiving, as an input, a 4-channel image, which is a combination of a 3-channel visible light image and a 1-channel infrared light image, and performing a process including a convolution operation. The fourth feature amount is, for example, a fourth feature map of 256 channels.

FIG. 14 shows an example in which each of the blocks D1, D2, and D4 includes a single convolution layer and a single pooling layer. However, at least one of the convolution layer and the pooling layer may be two or more layers. Although it is not shown in FIG. 14, in each of the blocks D1, D2, and D4, for example, an operational process for applying an activation function to the result of the convolution operation is performed.

D5 represents a block for detecting the positions of a visible object and a transparent object based on a 512-channel feature map obtained by combining the third feature map and the fourth feature map. Although FIG. 14 shows an example in which operations are performed by a convolution layer, a pooling layer, an upsampling layer, a convolution layer, and a softmax layer with respect to the 512-channel feature map, various modifications can be made to the actual structure. The upsampling layer is a layer for increasing the size in the vertical direction and the horizontal direction, and may otherwise be called an inverse pooling layer. The softmax layer is a layer for performing operations using the known softmax function.

For example, when classifying visible objects, transparent objects, and other objects, the output of the softmax layer is 3-channel image data. The image data of each channel is, for example, an image having the same number of pixels as that of the visible light image and the infrared light image, which are inputs. Each pixel of the first channel is numerical data of not less than 0 and not more than 1 that represents the probability that the pixel is a visible object. Each pixel of the second channel is numerical data of not less than 0 and not more than 1 that represents the probability that the pixel is a transparent object. Each pixel of the third channel is numerical data of not less than 0 and not more than 1 that represents the probability that the pixel is an object other than visible or transparent object. The output of the neural network in this embodiment is the 3-channel image data. The output of the neural network may also be image data in which a label denoting an object having the highest probability is associated with its probability for each pixel. For example, there are three labels (0, 1, 2), wherein 0 is a visible object, 1 is a transparent object, and 2 is other objects. When the probability that the object is a visible object is 0.3, the probability that the object is a transparent object is 0.5, and the probability that the object is an object other than visible or transparent object is 0.2, the pixel in the output data is given a probability of 0.5 and a label of “1”, which denotes a transparent object. Although an example of classifying three objects is described here, the number in the classification is not limited to this example. For example, the processing section 120 may classify four or more types of objects, for example, the processing section 120 may further classify visible objects into people and roads.

The training data in the present embodiment includes a visible light image and an infrared light image captured coaxially, and position information associated with these images. The position information is, for example, information in which one of the labels 0, 1, or 2 is given to each pixel. As described above, in these labels, 0 represents a visible object, 1 represents a transparent object, and 2 represents other objects.

In the learning process, input data is first input to the neural network, and output data is acquired by performing a forward operation using the weight at that time. In the present embodiment, the input data is a 3-channel visible light image, a 1-channel infrared light image, and a 4-channel image obtained by combining the 3-channel visible light image and the 1-channel infrared light image. The output data obtained by the forward operation is, for example, the output of the softmax layer described above, which is 3-channel data in which the probability p0 that the pixel is a visible object, the probability p1 that the pixel is a transparent object, and the probability p2 that the pixel is other objects (wherein p0 to p2 are numbers of not less than 0 and not more than 1 and satisfies the equation p0+p1+p2=1) are associated with each other for each pixel.

The learning section 220 calculates an error function (loss function) based on the obtained output data and the correct answer labels. When the correct answer label is 0, the pixel is a visible object; therefore, the probability p0 of being a visible object should be 1, and the probability p1 of being a transparent object and the probability p2 of being other objects should be 0. Therefore, the learning section 220 calculates the degree of difference between 1 and p0 as an error function, and updates the weight so that the error decreases. Various types of error functions are known and can be widely applied in this embodiment. The weight is updated using, for example, the error back-propagation method; however, other methods may also be used. The learning section 220 may update the weight by calculating the error function based on the degree of difference between 0 and p1 and the degree of difference between 0 and p2.

The outline of the learning process based on a single data set has been described above. In the learning process, a large number of data sets are prepared, and an appropriate weight is learned by repeating the process. For example, a visible light image and an infrared light image may be acquired by moving the mobile body shown in FIGS. 9A to 9C during the learning phase. Training data is acquired by user's operation to add position information, which is a correct answer label, to the visible light image and the infrared light image. In this case, the learning device 200 shown in FIG. 12 may be configured integrally with the information processing device 100. Alternatively, the learning device 200 may be provided separately from the mobile body, and the learning process may be performed by acquiring the visible light image and the infrared light image from the mobile body. Alternatively, in the learning phase, the visible light image and the infrared light image may be acquired by using the imaging device having the same configuration as that of the imaging section 10 without using the mobile body itself.

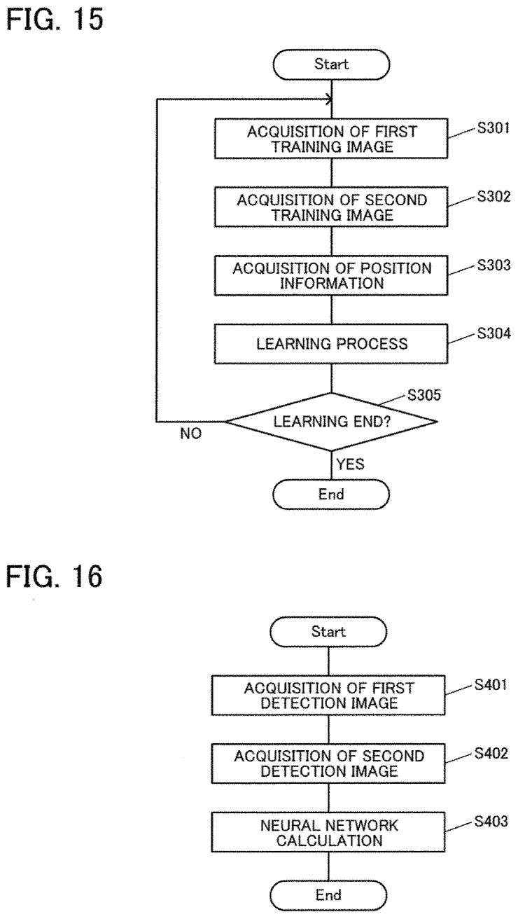

FIG. 15 is a flowchart explaining processing in the learning device 200. When this processing is started, the acquisition section 210 of the learning device 200 acquires a first training image, which is a visible light image, and a second training image, which is an infrared light image (S301, S302). Further, the acquisition section 210 acquires position information corresponding to the first training image and the second training image (S303). The position information is, for example, information given by the user as described above.

Next, the learning section 220 performs a learning process based on the acquired training data (8304). The process of S304 is a process of performing each of the forward operation, the calculation of an error function, and the update of the weight based on the error function once, for example, on the basis of a single set of data. Subsequently, the learning section 220 determines whether or not to end the machine learning (8305). For example, the learning section 220 divides the acquired large number of data sets into training data and validation data. The learning section 220 determines the accuracy by performing a process using the validation data with respect to the trained model acquired by performing a learning process based on training data. Since the validation data is associated with the position information, which is a correct answer label, the learning section 220 can determine whether or not the position information detected based on the trained model is correct. The learning section 220 determines to end the learning (Yes in S305) when the accuracy rate with respect to the validation data is equal to or greater than the predetermined threshold, and ends the processing. Alternatively, the learning section 220 may determine to end the learning when the processing shown in S304 is executed a predetermined number of times.

As described above, the first feature amount in the present embodiment is the first feature map obtained by performing a convolution operation using a first filter with respect to the first detection image. The second feature amount is the second feature map obtained by performing a convolution operation using a second filter with respect to the second detection image. The first filter is a group of filters used for the operation in the convolution layer shown in D11 of FIG. 14, and the second filter is a group of filters used for the operation in the convolution layer shown in D21 of FIG. 14. As described above, the first feature amount and the second feature amount are determined by performing convolution operation using different spatial filters with respect to the visible light image and the infrared light image. Therefore, it is possible to appropriately extract the features included in the visible light image and the features included in the infrared light image.

In addition, the filter characteristics of the first filter and the second filter are set by machine learning. By thus setting the filter characteristics using machine learning, it is possible to appropriately extract the characteristics of each object included in the visible light image and the infrared light image. For example, as shown in FIG. 14, it is also possible to extract various characteristics such as 256 channels. As a result, the accuracy of the position detection process based on the feature amount increases.

The fourth feature amount is the fourth feature map obtained by performing a convolution operation using a fourth filter with respect to the first detection image and the second detection image. As described above, the fourth feature amount can be obtained by performing a convolution operation using both the visible light image and the infrared light image as input. Further, the filter characteristics of the fourth filter is set by machine learning.

In the above description, the method of applying the machine learning to the case where both the visible object and the transparent object are distinctively detected was described. However, as in the first embodiment, the use of the machine learning for the method of detecting the position of the transparent object is also possible.

In this case, the acquisition section 210 of the learning device 200 acquires a data set in which a visible light image obtained by capturing an image of a plurality of target objects including the first target object and the second target object using visible light, an infrared light image obtained by capturing an image of a plurality of target objects using infrared light, and position information of the second target object in at least one of the visible light image and the infrared light image are associated with each other. The learning section 220 learns, through machine learning, conditions for detecting the position of the second target object in at least one of the visible light image and the infrared light image, based on the data set. In this way, it is possible to accurately detect the position of the transparent object.

### 3.2 Inference Process

The configuration example of the information processing device 100 in the present embodiment is the same as that shown in FIG. 1, except that the storage section 130 stores the trained model, which is the result of the learning process in the learning section 220.

FIG. 16 is a flowchart explaining an inference process in the information processing device 100. When this process is started, the acquisition section 110 acquires the first detection image which is a visible light image and the second detection image which is an infrared light image (S401, S402). The processing section 120 then performs a process for detecting the positions of the visible object and the transparent object in the visible light image and the infrared light image by being operated in accordance with a command from the trained model stored in the storage section 130 (S403). Specifically, the processing section 120 performs neural network operation using three types of data, i. e., the visible light image alone, the infrared light image alone, and both of the visible light image and the infrared light image, as input data.

In this way, it is possible to assume the position information of the visible object and the transparent object based on the trained model. By performing machine learning using a large number of training data, it is possible to perform a process using a trained model with high accuracy.

The trained model is used as a program module, which is a part of artificial intelligence software. The processing section 120 outputs data indicating the position information of the visible object and the position information of the transparent object in the visible light image and the infrared light image as inputs in accordance with a command from the trained model stored in the storage section 130.

The operation performed by the processing section 120 in accordance with the trained model, that is, the operation for outputting output data based on the input data, may be performed by software or by hardware. In other words, the convolution operation and the like in CNN may be performed by software. The operation may also be performed by a circuit device such as a field-programmable gate array (FPGA). Alternatively, the operation may be performed by a combination of software and hardware. As described above, the operation of the processing section 120 in accordance with the command from the trained model stored in the storage section 130 can be performed in various ways.

### 4. Fourth Embodiment

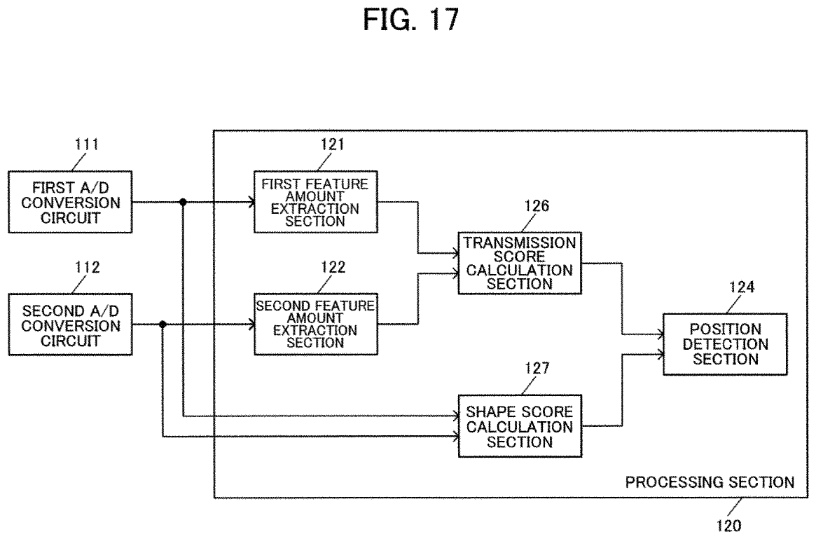

FIG. 17 is a diagram illustrating a configuration example of the processing section 120 according to a fourth embodiment. The processing section 120 of the information processing device 100 includes a transmission score calculation section 126 and a shape score calculation section 127 instead of the third feature amount extraction section 123 and the fourth feature amount extraction section 125 used in the second embodiment.

The transmission score calculation section 126 calculates a transmission score, which indicates the degree of transmission of visible light, in each target object in the visible light image and the infrared light image based on the first feature amount and the second feature amount. For example, since a transparent object, such as glass, transmits visible light and absorbs infrared light, the feature amount does not significantly appear in the first feature amount and appears mainly in the second feature amount. Therefore, when the transmission score is calculated by the difference between the first feature amount and the second feature amount, the transmission score of the transparent object becomes higher than that of the visible object. However, the transmission score in the present embodiment is not limited to information corresponding to the difference between the first feature amount and the second feature amount, insofar as it is information indicating the degree of transmission of visible light.

The shape score calculation section 127 calculates a shape score, which indicates the shape of an object, for each target object in the first detection image and the second detection image based on a third training image obtained by combining the first detection image and the second detection image. The third detection image is generated by adding the luminance of the first detection image to the luminance of the second detection image for each pixel. The third detection image has high robustness with respect to the lightness and darkness of the scene captured; therefore, it is possible to stably acquire information regarding the shape. On the other hand, since the luminance of the visible light image and the luminance of the infrared light image is combined, information regarding the degree of transmission of visible light is lost. Therefore, the shape score calculation section calculates a shape score that indicates only the shape of a target object independent of the degree of transmission of the visible light.

The position detection section 124 distinctively detects positions of both the transparent object and the visible object based on the transmission score and the shape score. For example, when the transmission score is a relatively high value and the shape score is a value indicating a predetermined shape corresponding to the transparent object, the position detection section 124 determines that the target object is a transparent object.

As described above, the processing section 120 of the information processing device 100 according to the present embodiment calculates a transmission score indicating the degree of transmission of visible light with respect to the plurality of target objects captured in the first detection image and the second detection image based on the first feature amount and the second feature amount. The processing section 120 also calculates a shape score indicating the shape of the plurality of target objects captured in the first detection image and the second detection image based on the first detection image and the second detection image. Further, the processing section 120 distinctively detects the positions of the first target object and the second target object in at least one of the first detection image and the second detection image based on the transmission score and the shape score. In this manner, the transmission score is calculated by individually calculating the first feature amount and the second feature amount, and the shape score is calculated using both of the visible light image and the infrared light image. Since each score can be calculated based on an appropriate input, the visible object and the transmission object can be detected with high accuracy.

In addition, machine learning may be applied to a method for calculating a transmission score and a shape score. In this case, the storage section 130 of the information processing device 100 stores the trained model. The trained model is machine-trained based on a data set in which the first training image obtained by capturing an image of a plurality of target objects using visible light, the second training image obtained by capturing an image of the plurality of target objects using infrared light, and position information of the first target object and position information of the second target object in at least one of the first training image and the second training image are associated with each other. The processing section 120 calculates a shape score and a transmission score based on the first detection image, the second detection image, and the trained model, and then distinctively detects the positions of both of the first target object and the second target object based on the transmission score and the shape score.

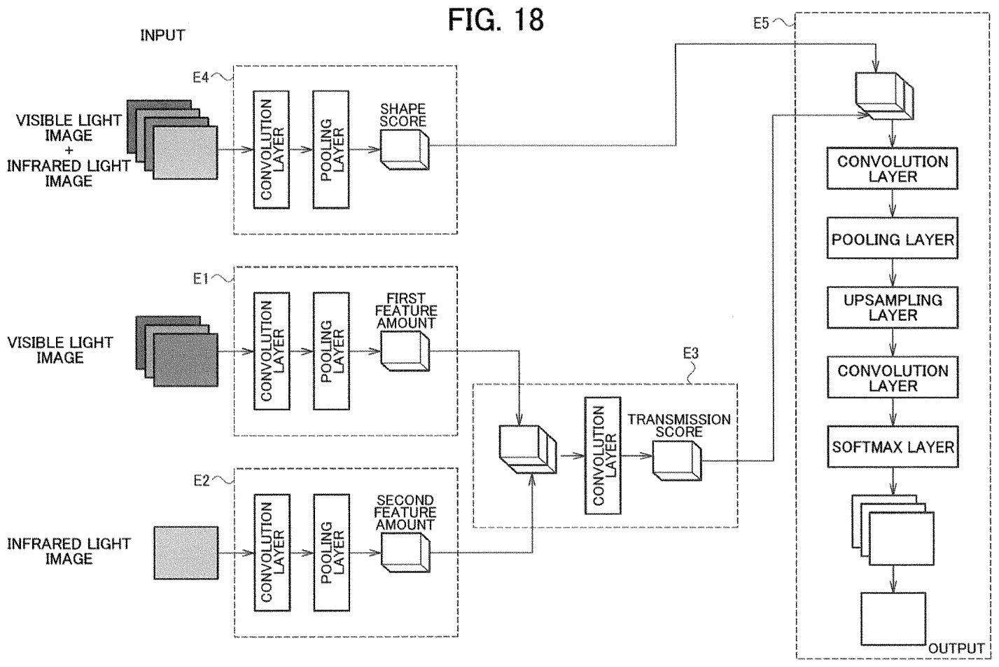

FIG. 18 is a schematic diagram illustrating a structure of a neural network of the present embodiment. E1 and E2 in FIG. 18 are the same as D1 and D2 in FIG. 14. E3 is a block for determining a transmission score based on the first feature map and the second feature map. In the present embodiment, the operation with respect to the first feature amount and the second feature amount is not limited to the operation based on the difference. For example, the transmission score is calculated by performing the convolution operation with respect to the 512-channel feature map obtained by combining the first feature map and the second feature map, which are 256-channel feature maps. The operation performed herein is not limited to the operation using the convolution layer; for example, the operation by the fully-connected layer, or other operations may also be performed. In this way, the calculation of the transmission score based on the first feature amount and the second feature amount can also be used as the object of the learning process. In other words, since the content of the calculation for determining the transmission score is optimized by machine learning, the transmission score is not limited to the feature amount corresponding to the difference, unlike the third feature amount.

E4 is a block for determining the shape score by receiving, as an input, a 4-channel image, which is a combination of a 3-channel visible light image and a 1-channel infrared light image, and performing a process including a convolution operation. The structure of E4 is the same as that of D4 in FIG. 14.

E5 detects positions of the visible object and the transparent object based on the shape score and the transmission score. Although FIG. 18 shows an example in which, as in D5 of FIG. 14, operations are performed by the convolution layer, the pooling layer, the upsampling layer, the convolution layer, and the softmax layer, various modifications can be made to the structure.

The specific learning process is the same as that in the third embodiment. More specifically, the learning section 220 performs a process of updating the weight, such as filter characteristics, based on a data set in which a visible light image, an infrared light image, and position information are associated with each other. When machine learning is performed, the user does not clearly specify that the output of E3 is information indicating the degree of transmission, and that the output of E4 is information indicating the shape. However, since the process of E4 is performed by combining the visible light image and the infrared light image, although shape recognition with high robustness is possible, information regarding the degree of transmission is lost. On the other hand, the first feature amount and the second feature amount can be individually processed in E3, and information regarding the degree of transmission remains. More specifically, when machine learning is performed to improve the accuracy of the position detection for a transparent object, the weight in E1-E3 is expected to be a value for outputting an appropriate transmission score, and the weight in E4 is expected to be a value for outputting an appropriate shape score. In other words, by using the structure shown in FIG. 18 in which three types of input are performed, and the process results are combined after processing is separately performed for each input, it is possible to establish a trained model for detecting the position of a target object based on the shape score and the transmission score.

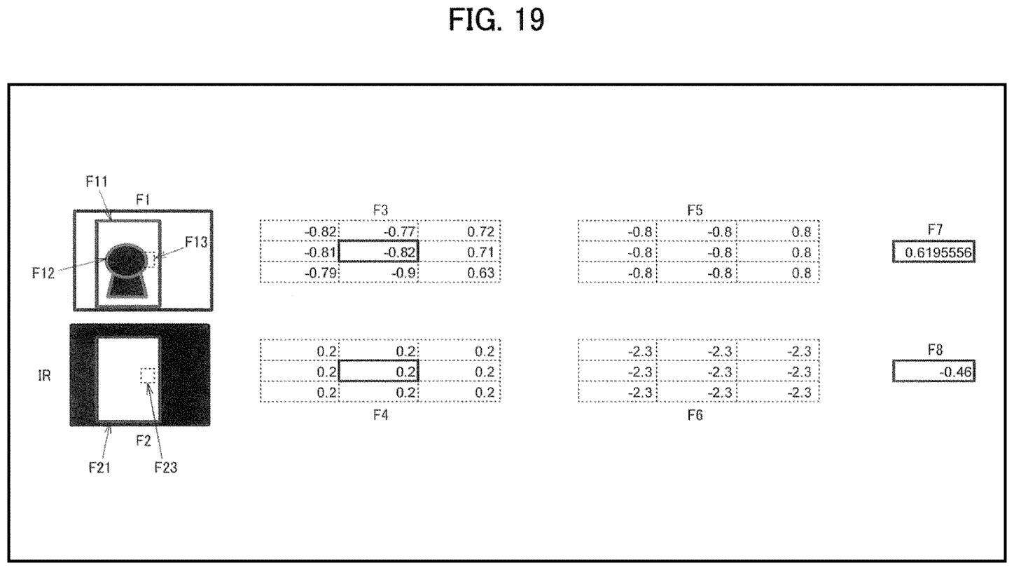

FIG. 19 is a schematic diagram explaining a transmission score calculation process. In FIG. 19, F1 represents a visible light image, F11 represents a region where a transparent object exists, and F12 represents a visible object, which is present in the back side of the transparent object. F2 is an infrared light image in which an image of the transparent object represented by F21 is captured, and an image of the visible object corresponding to F12 is not captured.

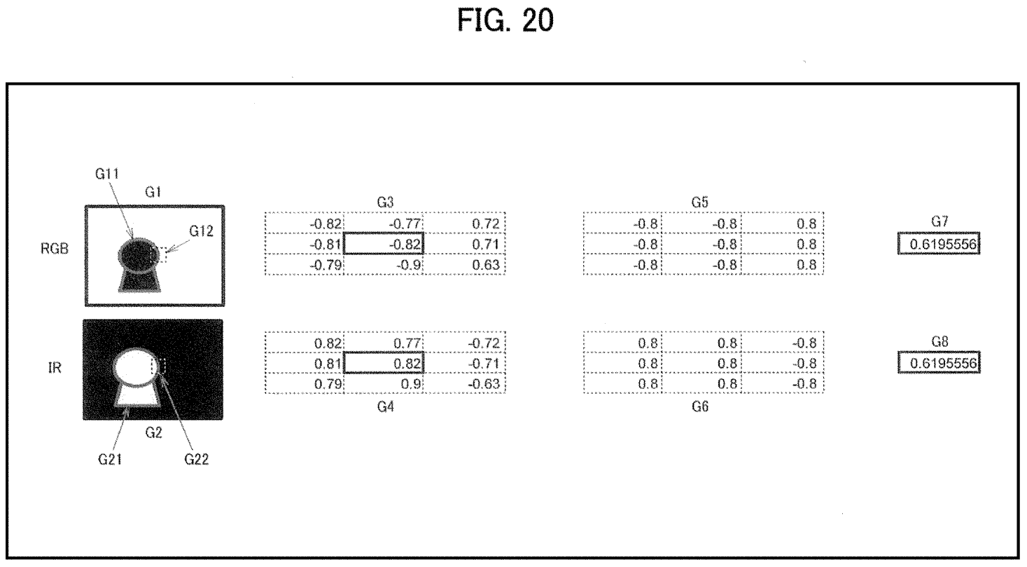

F3 represents a pixel value of a region corresponding to F13 in the visible light image. In the visible light image, F13 is a boundary between F12, which is a visible object, and the background. Since the background is bright in this example, the pixel values in the left and central columns are small, and the pixel values in the right column are large. The pixel values in FIG. 19 and those in FIG. 20 (described later) indicate values normalized to fall within a range from −1 to +1. By performing an operation using a filter having the characteristics shown in F5 with respect to the region F3, a score value F7, which is relatively large, is output. F5 is one of the filters whose characteristics are set as a result of learning, for example, a filter for extracting a vertical edge.

F4 represents a pixel value of a region corresponding to F23 in the infrared light image. In the infrared light image, since F23 corresponds to a transparent object, the contrast is low. Specifically, the pixel values are substantially the same in the entire area of F4. Therefore, by performing an operation using a filter having the characteristics shown in F6, a score value F8, which is a negative value having a relatively large absolute value, is output. F6 is one of the filters whose characteristics are set as a result of learning, for example, a filter for extracting a flat region.

In the example shown in FIG. 19, the processing section 120 is capable of determining a transmission score by subtracting F8 from F7. However, in the method of the present embodiment, the way of performing the method of determining the transmission score by using the first feature amount and the second feature amount is also an object of the machine learning. Therefore, the transmission score can be calculated by flexible processing according to the specified filter characteristics.

FIG. 20 is a schematic diagram explaining a shape score calculation process. In FIG. 20, G1 represents a visible light image, and G11 represents a visible object. G2 represents an infrared light image, and an image of a visible object G21 similar to G11 is captured.

G3 represents a pixel value of a region corresponding to G12 in the visible light image. In the visible light image, G12 is a boundary between G11, which is a visible object, and the background. Since the background is bright in this example, the pixel values in the left and central columns are small, and the pixel values in the right column are large. Therefore, by performing an operation using a filter having the characteristics shown in G5, a score value G7, which is relatively large, is output. G5 is one of the filters whose characteristics are set as a result of learning, for example, a filter for extracting a vertical edge.

G4 represents a pixel value of a region corresponding to G22 in the infrared light image. In the infrared light image, G22 is a boundary between G21, which is a visible object, and the background. In the infrared light image, since a visible object such as a human serves as a heat source, the captured image is brighter than that of the background region. Therefore, the pixel values in the left and central columns are large, and the pixel values in the right column are small. Therefore, by performing an operation using a filter having the characteristics shown in G6, a score value G8, which is relatively large, is output. G6 is one of the filters whose characteristics are set as a result of learning, for example, a filter for extracting a vertical edge. G5 and G6 have different gradient directions.

The shape score is determined by a convolution operation with respect to a 4-channel image. For example, the shape score is a feature map including the result of adding G7 to G8. In the example shown in FIG. 20, the information in which the value increases in the region corresponding to the edge of the object is obtained as the shape score.

Although the embodiments to which the present disclosure is applied and the modifications thereof have been described in detail above, the present disclosure is not limited to the embodiments and the modifications thereof, and various modifications and variations in components may be made in implementation without departing from the spirit and scope of the present disclosure. The plurality of elements disclosed in the embodiments and the modifications described above may be combined as appropriate to implement the present disclosure in various ways. For example, some of all the elements described in the embodiments and the modifications may be deleted. Furthermore, elements in different embodiments and modifications may be combined as appropriate. Thus, various modifications and applications can be made without departing from the spirit and scope of the present disclosure. Any term cited with a different term having a broader meaning or the same meaning at least once in the specification and the drawings can be replaced by the different term in any place in the specification and the drawings.

What is claimed is:

1. An information processing device comprising:
an acquisition interface that acquires a first detection image obtained by capturing an image of a plurality of target objects using visible light and a second detection image obtained by capturing an image of the plurality of target objects using infrared light, the plurality of target objects including a first target object and a second target object, the second target object being more transparent to the visible light than the first target object; and
a processor including hardware,
the processor being configured to:
obtain a first feature amount based on the first detection image;
obtain a second feature amount based on the second detection image;
calculate a third feature amount corresponding to a difference between the first feature amount and the second feature amount, and
detect a position of the second target object in at least one of the first detection image and the second detection image, based on the third feature amount.

2. The information processing device as defined in claim 1, wherein
the first feature amount is information indicating a contrast of the first detection image,
the second feature amount is information indicating a contrast of the second detection image, and
the processor detects the position of the second target object in at least one of the first detection image and the second detection image, based on the third feature amount corresponding to a difference between the contrast of the first detection image and the contrast of the second detection image.

3. The information processing device as defined in claim 1, wherein
the processor is configured to:
obtain a fourth feature amount indicating a feature of the first target object based on the first detection image and the second detection image, and
distinctively detect a position of the first target object and the position of the second target object based on the third feature amount and the fourth feature amount.

4. The information processing device as defined in claim 3, comprising
a memory that stores a trained model,
wherein the trained model is machine-trained
based on a data set in which a first training image obtained by capturing an image of the plurality of target objects using visible light, a second training image obtained by capturing an image of the plurality of target objects using infrared light, and position information of the first target object and position information of the second target object in at least one of the first training image and the second training image are associated with each other, and
the processor is configured to:
distinctively detect the position of the first target object and the position of the second target object in at least one of the first detection image and the second detection image based on the first detection image, the second detection image, and the trained model.

5. The information processing device as defined in claim 4, wherein
the first feature amount is a first feature map obtained by performing a convolution operation using a first filter with respect to the first detection image, and
the second feature amount is a second feature map obtained by performing a convolution operation using a second filter with respect to the second detection image.

6. The information processing device as defined in claim 5, wherein
filter characteristics of the first filter and the second filter are set by the machine learning.

7. The information processing device as defined in claim 4, wherein
the fourth feature amount is a fourth feature map obtained by performing a convolution operation using a fourth filter with respect to the first detection image and the second detection image.

8. The information processing device as defined in claim 1, comprising
a memory that stores a trained model,
wherein the trained model is machine-trained based on a data set in which a first training image obtained by capturing an image of the plurality of target objects using visible light, a second training image obtained by capturing an image of the plurality of target objects using infrared light, and position information of the second target object in at least one of the first training image and the second training image are associated with each other, and
the processor is configured to:
detect a position of the second target object in at least one of the first detection image and the second detection image based on the first detection image, the second detection image, and the trained model.

9. The information processing device as defined in claim 8, wherein
the first feature amount is a first feature map obtained by performing a convolution operation using a first filter with respect to the first detection image, and
the second feature amount is a second feature map obtained by performing a convolution operation using a second filter with respect to the second detection image, and
filter characteristics of the first filter and the second filter are set by the machine learning.

10. An information processing device, comprising:
an acquisition interface that acquires a first detection image obtained by capturing an image of a plurality of target objects using visible light and a second detection image obtained by capturing an image of the plurality of target objects using infrared light, the plurality of target objects including a first target object and a second target object, the second target object being more transparent to the visible light than the first target object; and
a processor including hardware,
the processor being configured to:
obtain a first feature amount based on the first detection image;
obtain a second feature amount based on the second detection image:
calculate a transmission score indicating a degree of transmission of the visible light with respect to the plurality of target objects whose image is captured in the first detection image and the second detection image, based on the first feature amount and the second feature amount,
calculate a shape score indicating a shape of the plurality of target objects whose image is captured in the first detection image and the second detection image, based on the first detection image and the second detection image, and
distinctively detect a position of the first target object and a position of the second target object in at least one of the first detection image and the second detection image, based on the transmission score and the shape score.

11. The information processing device as defined in claim 10, comprising
a memory that stores a trained model,
wherein the trained model is machine-trained based on a data set in which a first training image obtained by capturing an image of the plurality of target objects using visible light, a second training image obtained by capturing an image of the plurality of target objects using infrared light, and position information of the first target object and position information of the second target object in at least one of the first training image and the second training image are associated with each other, and
the processor is configured to:
calculate the shape score and the transmission score based on the first detection image, the second detection image, and the trained model, and distinctively detect the position of the first target object and the position of the second target object based on the transmission score and the shape score.

12. The information processing device as defined in claim 1, further comprising:
an imaging device that captures an image of the plurality of target objects using visible light with a first optical axis, and captures an image of the plurality of target objects using infrared light with a second optical axis, which corresponds to the first optical axis,
wherein the acquisition interface acquires the first detection image and the second detection image based on the image-capturing by the imaging device.

13. The information processing device as defined in claim 10, further comprising
an imaging device that captures an image of the plurality of target objects using visible light with a first optical axis, and captures an image of the plurality of target objects using infrared light with a second optical axis, which corresponds to the first optical axis,
wherein the acquisition interface acquires the first detection image and the second detection image based on the image-capturing by the imaging device.

14. A mobile body comprising the information processing device as defined in claim 1.

15. A mobile body comprising the information processing device as defined in claim 10.

16. A learning device, comprising:
an acquisition interface that acquires a data set in which a visible light image obtained by capturing an image of a plurality of target objects including a first target object and a second target object, which is more transparent to visible light than the first target object, using the visible light, an infrared light image obtained by capturing an image of the plurality of target objects using infrared light, and position information of the second target object in at least one of the visible light image and the infrared light image are associated with each other, and
a processor that learns, through machine learning, conditions for detecting a position of the second target object in at least one of the visible light image and the infrared light image, based on the data set.

17. The learning device as defined in claim 16, wherein
the data set is obtained by the visible light image, the infrared light image, the position information of the second target object, and position information of the first target object in at least one of the visible light image and the infrared light image being associated with each other, and
the processor is configured to:
learn, through machine learning, conditions for distinctively detecting a position of the first target object and a position of the second target object in at least one of the visible light image and the infrared light image, based on the data set.
